(19) United States
(12) Patent Application Publication
(10) Pub. No.: US 2006/0294186 A1
(43) Pub. Date: Dec. 28, 2006

(54) System and method for enriched multimedia conference services in a telecommunications network

(75) Inventors: Nhut Nguyen, Richardson, TX (US); Hai Duong Nguyen, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/364,416

(22) Filed: Feb. 27, 2006

Related U.S. Application Data
(60) Provisional application No. 60/694,417, filed on Jun. 27, 2005.

(51) Int. Cl. G06F 15/16

(52) U.S. Cl. 709/204; 709/227

(57) ABSTRACT

In a telecommunications network, a system for providing multimedia conference services includes a conferencing server capable of receiving a request to participate in a multimedia conference from a conference participant. The conferencing server is further capable of determining a characteristic of the conference, requesting a preference of the conference participant, and connecting the conference participant to the conference. Finally, the conferencing server is capable of providing multimedia conference services to the conference participant according to the characteristic of the conference and the preference of the conference participant.

### CROSS-REFERENCE TO RELATED APPLICATION AND CLAIM OF PRIORITY

The present application is related to U.S. Provisional Patent No. 60/694,417, filed Jun. 27, 2005, entitled “Methods and Apparatus for Enriched and Sophisticated Multimedia Conferencing Services”. U.S. Provisional Patent No. 60/694,417 is assigned to the assignee of the present application and is hereby incorporated by reference into the present disclosure as if fully set forth herein. The present application hereby claims priority under 35 U.S.C. §119(e) to U.S. Provisional Patent No. 60/694,417.

### TECHNICAL FIELD OF THE INVENTION

The present application relates generally to providing services in a telecommunications network and, more specifically, to providing multimedia conference services in a telecommunications network.

### BACKGROUND OF THE INVENTION

Telecommunications networks may provide conference call services. Such services allow two or more parties to participate in a conference call. Where the conference participants are utilizing Plain Old Telephone Service (POTS) equipment, or other audio-only equipment, the conference services may be restricted to enabling all participants in the conference call to speak and listen to the other participants. Where the conference participants are using so-called “smart phones” that include web browser functionality, the conference services may include the ability to conduct video conferences.

Typically, however, telecommunications networks require all conference participant equipment to have at least a minimum capability in order to participate in a multimedia conference such as a video conference. Audio-only phones may be prevented from participating in a video conference, for example. Alternatively, telecommunications networks may restrict conference participants from using equipment capabilities that are not shared by all participants. In such a case, conference participants using a mixture of POTS phone and smart phone users may be restricted to share audio only in a conference call.

Even where all users are utilizing equipment of similar capabilities, telecommunications networks may provide certain conference services to all participants in the same way, regardless of participants' preferences. For example, video may be provided at a single data rate or a single window size.

Therefore, there is a need in the art for improved conference services in telecommunications networks. In particular, there is a need for a conferencing server that is capable of providing conference services to conference participants of different equipment capabilities and participant preferences.

### SUMMARY OF THE INVENTION

A system and method is provided that is capable of providing multimedia conference services in a telecommunications network. Multimedia conference services may be provided for conferences of various types to conference participants having different equipment capabilities and preferences. As telecommunication equipment is developed having new capabilities, the system and method may be used to provide conference services for multimedia conferences of new types made possible by the new equipment capabilities.

The steps of the method include the step of receiving a request to participate in a multimedia conference from a conference participant. The steps further include determining a characteristic of the conference, requesting a preference of the conference participant, and connecting the conference participant to the conference. Finally, the steps include providing multimedia conference services to the conference participant according to the characteristic of the conference and the preference of the conference participant.

The system includes a conferencing server capable of receiving a request to participate in a multimedia conference from a conference participant. The conferencing server is further capable of determining a characteristic of the conference, requesting a preference of the conference participant, and connecting the conference participant to the conference. Finally, the conferencing server is capable of providing multimedia conference services to the conference participant according to the characteristic of the conference and the preference of the conference participant.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system according to an exemplary embodiment of the disclosure;

FIG. 2 is a flow diagram illustrating a method of providing multimedia conference services according to an exemplary embodiment of the disclosure; and

FIG. 3 presents a message flow diagram depicting a conference participant joining a multimedia conference according to an exemplary embodiment of the disclosure.

### DETAILED DESCRIPTION OF THE INVENTION

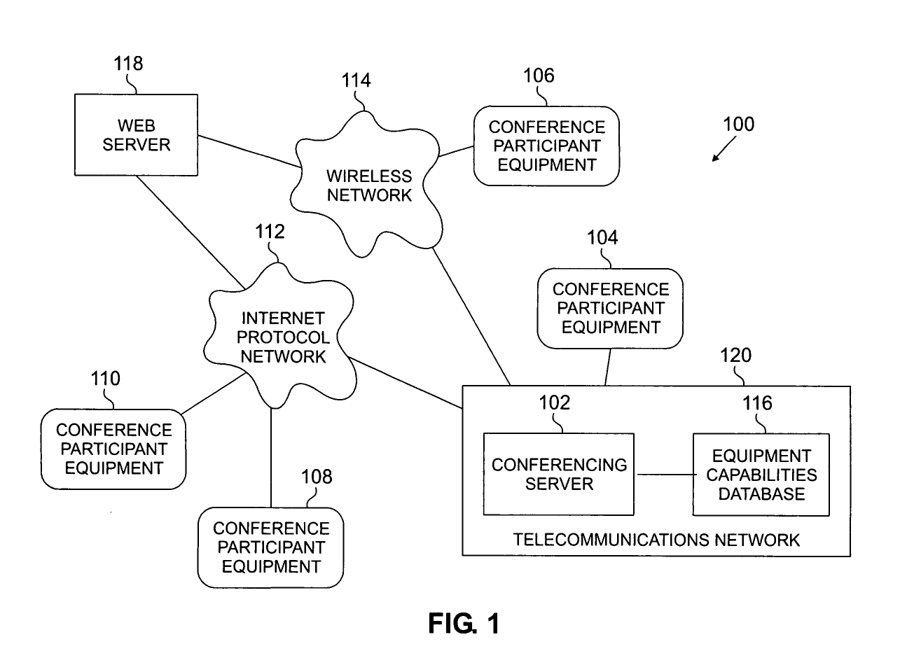

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunications network.

FIG. 1 illustrates a system 100 according to an exemplary embodiment of the disclosure. A telecommunications network 120 includes a conferencing server 102, which may provide multimedia conference services to conference participants utilizing conference participant equipment (CPE) 104-110. The CPEs 108 and 110 may be internet-capable equipment, such as SIP devices or smart phones, that communicate with the conferencing server 102 via an Internet protocol network 112. The CPE 104 may be a POTS device that communicates with the conferencing server 102 via a media gateway (not shown). The CPE 106 may be a wireless device that communicates with the conferencing server 102 via a wireless network 114.

The conferencing server 102 and the CPEs 108 and 110 may also communicate with a web server 118 via the Internet protocol network 112. Similarly, the CPE 106 may communicate with the web server 118 via the wireless network 114. The telecommunications network 120 may also include an equipment capabilities database 116 that communicates with conferencing server 102. The equipment capabilities database 116 may store information about the capabilities of one or more of the CPEs 104-110.

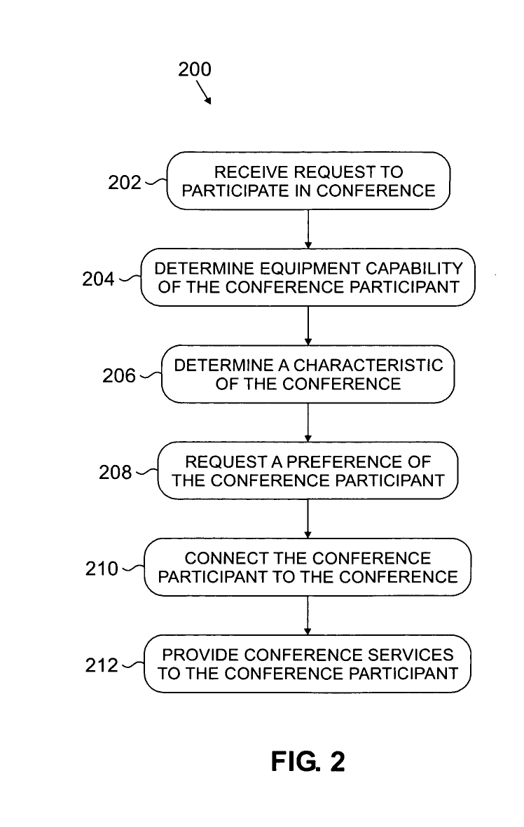

FIG. 2 is a flow diagram illustrating a method 200 of providing multimedia conference services according to an exemplary embodiment of the disclosure. The method 200 includes steps that the conferencing server 102 may take in providing conference services to the CPEs 104-110.

In step 202, the conferencing server 102 may receive from one of the CPEs 104-110 a request to participate in a multimedia conference. The conference may be a scheduled conference that the CPE is joining. Alternatively, the requesting one of CPEs 104-110 may already be participating in a call with another CPE and be attempting to add a third CPE to the call, creating an ad hoc conference. In another possibility, the requesting one of CPEs 104-110 may be attempting to join a so-called ‘meeting room’—that is, an ongoing conference that participants may join at any time.

The requesting one of CPEs 104-110 may have provided information in the request relating to the capabilities of the equipment of the requesting one of CPEs 104-110. In step 204 of the method 200, the conferencing server may evaluate any such information to determine the capabilities and/or functionality of the requesting one of CPEs 104-110. For example, the information may indicate that the requesting one of CPEs 104-110 is a POTS device, smart phone, or other type of device. This information may be in the form of an encoded word that the conferencing server 102 sends to the equipment capabilities database (ECD) 116 in a query. In response, the ECD 116 may respond to the query with further information about the capabilities of the equipment of the requesting one of CPEs 104-110. Alternatively, the ECD 116 may respond to the query with an indication that it has no information about the capabilities of the equipment of the requesting one of CPEs 104-110.

Whether the multimedia conference is scheduled, ad hoc, in a meeting room, or another type of conference, step 206 of the method 200 includes the conferencing server 102 determining one or more characteristics of the multimedia conference. For example, the conference may be a video conference. The conference may include dynamic ‘whiteboard’ web pages that one or more conference participants modify while other conference participants view the changes. The conference may be a conference in which the participants review and discuss video or other media clips.

In step 208 of the method 200, the conferencing server 102 may request information regarding one or more preferences of the conference participant relating to participation in the multimedia conference. Where the conferencing server 102 has obtained information regarding the capabilities of the equipment of the requesting one of CPEs 104-110 (either from the requesting one of CPEs 104-110 or from the ECD 116), the conferencing server 102 is capable of making this request in a format that makes appropriate use of the capabilities of the requesting one of the CPEs 104-110.

For example, if the requesting one of the CPEs 104-110 has a web browser, the request may be made in the form of a web page containing choices that the conference participant may make and submit to the conferencing server 102. Alternatively, if the requesting one of the CPEs 104-110 is a POTS phone, the request may be made with an interactive voice response (IVR) system capable of presenting the conference participant with choices and accepting spoken or telephone keypad responses.

The choices the conference participant is given in the request for a preference may be dynamically formulated by the conferencing server 102 according to both the characteristics of the multimedia conference and the capabilities of the requesting one of the CPEs 104-110. For example, if the requesting one of the CPEs 104-110 is a POTS phone, the conferencing server 102 may use an IVR to request a choice of whether to record a name before joining the conference and/or whether to join the conference without entering a password number. Alternatively, if the conference is a video conference and the requesting one of the CPEs 104-110 is a smart phone, the conferencing server 102 may use a dynamically created web page to request a preferred bit rate and/or video format for the video signal provided to the requesting one of the CPEs 104-110.

In step 210 of the method 200, the conferencing server 102 may connect the requesting one of the CPEs 104-110 to any other conference participants. Once connected, the conferencing server 102 in step 212 may provide multimedia conference services to the requesting one of the CPEs 104-110 according to the capabilities of the requesting one of the CPEs 104-110 determined in step 204, the characteristics of the multimedia conference determined in step 206, and the preference expressed by the conference participant in step 208. If in steps 202 and 204 no information is received regarding the capabilities of the requesting one of the CPEs 104-110, then in step 212 the conferencing server 102 may assume a minimal level of capability for the requesting one of the CPEs 104-110 and provide conference services accordingly.

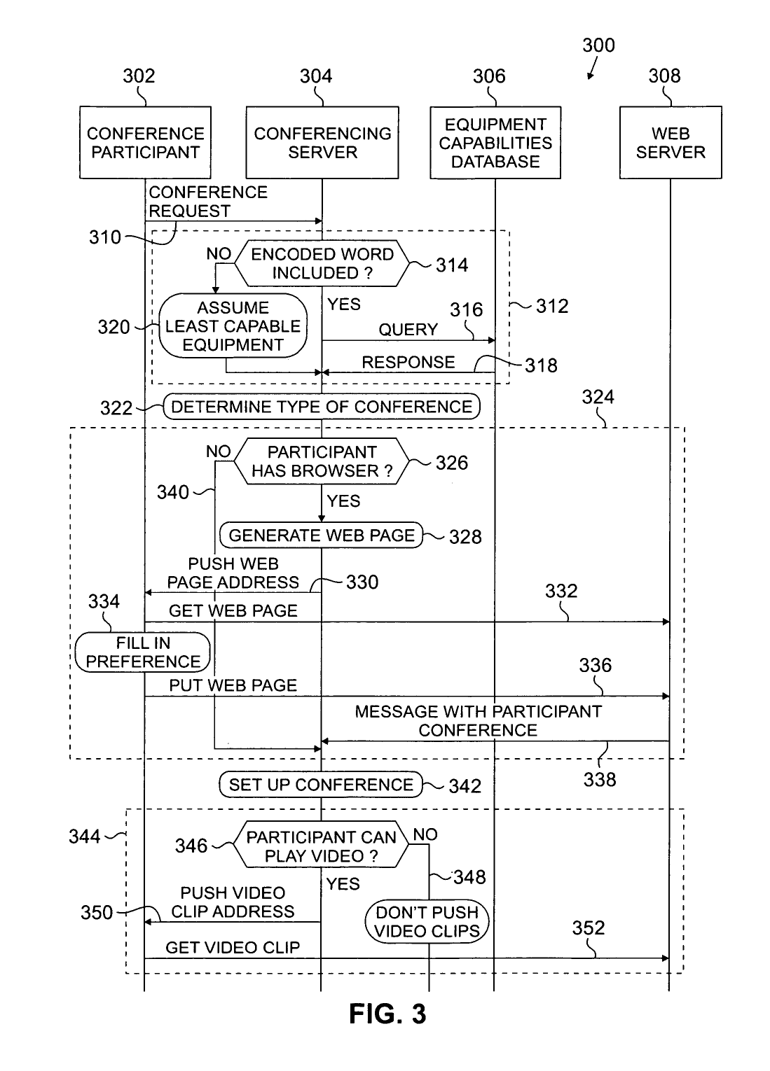

FIG. 3 presents a message flow diagram depicting a process 300 of a conference participant 302 joining a multimedia conference according to an exemplary embodiment of the disclosure. The conference participant 302 may initiate the process 300 by sending a conference request message 310 to a conferencing server 304. Having received the request, the conferencing server 304 may then perform a collection of actions 312 to determine one or more equipment capabilities of the conference participant 302.

In step 314, the conferencing server may examine the request message 310 to determine whether it includes information relating to the equipment capability of the conference participant 302. Such information may be in the form of an encoded word representing the type of equipment being used by the conference participant 302.

If present, the encoded word may be sent in a query 316 to an equipment capabilities database 306. In a response 318, the equipment capabilities database 306 may provide information that relates to the equipment capability of the conference participant 302. If no encoded word or other information is present in the request message 310, then the conferencing server 304 may assume in step 320 a capability of the equipment being used by the conference participant 302. For example, the conferencing server 304 may assume a minimal level of capability, in order to ensure that the conference participant 302 will be able to participate in the multimedia conference to at least some extent.

Having determined or assumed a capability of the equipment used by the conference participant 302, in step 322 the conferencing server determines one or more characteristics of the multimedia conference that conference participant 302 is creating or joining. If the conference is a scheduled conference or a meeting room, the conference organizer may have specified the characteristics of the conference. If the conference is an ad hoc conference, its characteristics may have been specified in the request message 310 or may be determined from the capabilities of the equipment being used by the conference participant 302.

Based upon the equipment capability of the conference participant 302 and the characteristics of the multimedia conference, the conferencing server may perform a series of actions 324 to obtain a preference of the conference participant 302 relating to the conference. In step 326, the conferencing server may determine whether the conference participant 302 has a browser capability. If so, the conferencing server 304 in step 328 may generate a web page on a web server 308 designed to elicit from the conference participant 302 choices relating to its participation in the multimedia conference. Alternatively, web pages suited to various possible combinations of multimedia conference type and conference participant equipment capability may have already been generated on the web server 308. In such an embodiment of the disclosure, the conferencing server 304 may select an appropriate web page on the web server 308 for use in requesting a preference from the conference participant 302.

In step 330, the conferencing server 302 may push an address of the generated or selected web page on the web server 308 to the conference participant 302. The conference participant 302 may then get the web page from the web server 308 in step 332. In step 334, the conference participant 302 may use its browser capability to interact with the web page in order to indicate one or more preferences for the multimedia conference. Once the interaction is completed, the conference participant 302 may put the web page to the web server 308 in step 336, whereupon the web server 308 may send a message 338 to the conferencing server 304 with the preference expressed by the conference participant 302.

In the embodiment of the disclosure shown in FIG. 3, if the conferencing server 304 determines in step 326 that the conference participant 302 does not have web browser capability, the remaining steps of the sequence of actions 324 are not performed, as shown at 340. In such a situation, the conferencing server 304 may not request a preference of the conference participant 302. In another embodiment of the disclosure, the absence of a web browser capability in the conference participant 302 may result in the conferencing server 304 requesting a preference from the conference participant 302 by some other means, for example an interactive voice response system.

Having determined the characteristics of the multimedia conference and the equipment capability and preference of the conference participant 302, in step 342 the conferencing server 304 may set up the multimedia conference and connect the conference participant 302 with other conference participants. The conferencing server 304 may then continue providing multimedia conference services according to one or more of the characteristic of the multimedia conference, the equipment capability and the preference of the conference participant 302. An example of this provision of multimedia conference services is shown in sequence of actions 344.

If the multimedia conference includes pushing a video clip to conference participants, in step 346 the conferencing server 304 may determine whether the conference participant 302 has the capability to play video clips. If not, in step 348 the conferencing server 304 may continue without pushing the video clip to the conference participant 302. On the other hand, if the conference participant 302 is able to play video clips, the conferencing server 304 may push the address on the web server 308 of the video clip to the conference participant 302. The conference participant 302 may then get the video clip from the web server 308 and play it.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing multimedia conference services in a telecommunications network, the method comprising:
receiving a request to participate in a multimedia conference from a conference participant;
determining a characteristic of the multimedia conference;
requesting a preference of the conference participant;
connecting the conference participant to the multimedia conference; and
providing multimedia conference services to the conference participant according to the characteristic of the multimedia conference and the preference of the conference participant.

2. The method as set forth in claim 1, wherein the step of receiving a request to participate in a multimedia conference from a conference participant further comprises determining from information in the request an equipment capability of the conference participant and wherein the step of providing multimedia conference services to the conference participant further comprises providing multimedia conference services to the conference participant according to the equipment capability of the conference participant.

3. The method as set forth in claim 2, wherein the step of determining from information in the request an equipment capability of a conference participant further comprises querying an equipment capabilities database to determine the equipment capability of the conference participant.

4. The method as set forth in claim 1, wherein the step of receiving a request to participate in a multimedia conference from a conference participant further comprises determining that the request includes no indication of an equipment capability of the conference participant and wherein the step of providing multimedia conference services to the conference participant further comprises providing multimedia conference services to the conference participant according to an assumed equipment capability of the conference participant.

5. The method as set forth in claim 1, wherein the step of receiving a signal indicating an equipment capability of a conference participant further comprises determining that the equipment of the conference participant includes a web browser, and wherein the step of requesting a preference of the conference participant further comprises:
selecting, based upon the equipment capability of the conference participant and the characteristic of the multimedia conference, a web page on a web server to obtain the preference of the conference participant;
sending an address of the web page on the web server to the web browser of the conference participant; and
receiving a message from the web server indicating the preference of the conference participant.

6. The method as set forth in claim 5, wherein the step of selecting a web page further comprises generating the web page on the web server in accordance with the equipment capability of the conference participant and the characteristic of the multimedia conference.

7. The method as set forth in claim 1, wherein the conference is a video conference and the equipment of the conference participant includes a web browser and the step of providing multimedia conference services to the conference participant further comprises sending an address of a video clip on a web server to the web browser of the conference participant.

8. A system for providing multimedia conference services in a telecommunications network, the system comprising:
a conferencing server capable of:
receiving a request to participate in a multimedia conference from a conference participant;
determining a characteristic of the multimedia conference;
requesting a preference of the conference participant;
connecting the conference participant to the multimedia conference; and
providing multimedia conference services to the conference participant according to the characteristic of the multimedia conference and the preference of the conference participant.

9. The system as set forth in claim 8, wherein the conferencing server is further capable of determining from information in the request an equipment capability of the conference participant and providing multimedia conference services to the conference participant further according to the equipment capability of the conference participant.

10. The system as set forth in claim 9, wherein the system further comprises an equipment capabilities database and wherein the conferencing server is further capable of querying the equipment capabilities database to determine the equipment capability of the conference participant.

11. The system as set forth in claim 8, wherein the conferencing server is further capable of determining that the request includes no indication of an equipment capability of the conference participant and providing multimedia conference services to the conference participant further according to an assumed equipment capability of the conference participant.

12. The system as set forth in claim 8, wherein the conferencing server is further capable of:
determining that the equipment of the conference participant includes a web browser;
selecting, based upon the equipment capability of the conference participant and the characteristic of the multimedia conference, a web page on a web server to obtain the preference of the conference participant;
sending an address of the web page on the web server to the web browser of the conference participant; and
receiving a message from the web server indicating the preference of the conference participant.

13. The system as set forth in claim 12, wherein the conferencing server is further capable of generating the web page on the web server in accordance with the equipment capability of the conference participant and the characteristic of the multimedia conference.

14. The system as set forth in claim 8, wherein the multimedia conference is a video conference and the equipment of the conference participant includes a web browser and the conferencing server is further capable of sending an address of a video clip on a web server to the web browser of the conference participant.

15. Logic for use in a conferencing server of a telecommunications network, wherein the logic is operable to
receive a request to participate in a multimedia conference from a conference participant;
determine a characteristic of the multimedia conference;
request a preference of the conference participant;
connect the conference participant to the conference; and
provide multimedia conference services to the conference participant according to the characteristic of the multimedia conference and the preference of the conference participant.

16. The logic as set forth in claim 15, wherein the logic is further operable to determine from information in the request an equipment capability of the conference participant and provide multimedia conference services to the conference participant further according to the equipment capability of the conference participant.

17. The logic as set forth in claim 16, wherein the logic is further operable to query an equipment capabilities database to determine the equipment capability of the conference participant.

18. The logic as set forth in claim 15, wherein the logic is further operable to determine that the request includes no indication of an equipment capability of the conference participant and provide multimedia conference services to the conference participant further according to an assumed equipment capability of the conference participant.

19. The logic as set forth in claim 15, wherein the logic is further operable to:
determine that the equipment of the conference participant includes a web browser;
select, based upon the equipment capability of the conference participant and the characteristic of the multimedia conference, a web page on a web server to obtain the preference of the conference participant;
send an address of the web page on the web server to the web browser of the conference participant; and
receive a message from the web server indicating the preference of the conference participant.

20. The logic as set forth in claim 19, wherein the logic is further operable to generate the web page on the web server in accordance with the equipment capability of the conference participant and the characteristic of the multimedia conference.

21. The logic as set forth in claim 15, wherein the multimedia conference is a video conference and the equipment of the conference participant includes a web browser and the logic is further operable to send an address of a video clip on a web server to the web browser of the conference participant.
